(19) United States
(12) Patent Application Publication
(10) Pub. No.: US 2014/0040375 A1
(43) Pub. Date: Feb. 6, 2014

(54) DISTRIBUTED SUBSCRIPTION BASED NOTIFICATION SERVICE FOR INTEGRATED PETRO-TECHNICAL APPLICATION ENVIRONMENT

(71) Applicant: Schlumberger Technology Corporation, Sugar Land, TX (US)

(72) Inventors: Priya Kannan, Katy, TX (US); Rachana A. Palacharla, Houston, TX (US); Raj Kannan, Houston, TX (US); Cristiano da Silva Marcolino, Ipanema (BR)

(73) Assignee: Schlumberger Technology Corporation, Sugar Land, TX (US)

(21) Appl. No.: 13/955,694

(22) Filed: Jul. 31, 2013

Related U.S. Application Data
(60) Provisional application No. 61/677,894, filed on Jul. 31, 2012.

(51) Int. Cl. H04L 29/08

(52) U.S. Cl. CPC H04L 67/10
USPC 709/204

(57) ABSTRACT

A method, apparatus, and program product implement a distributed subscription-based notification service for an integrated petro-technical application environment to facilitate the reporting of updates to oilfield data from a shared repository by a plurality of users. Users are permitted to generate custom notification subscriptions in a petro-technical application, such that oilfield data in the shared repository that meets subscription criteria associated with the notification subscriptions and that has been updated may be identified and used to generate a notification in the petro-technical application, thereby enabling individual users to customize their respective notifications based upon the particular types of data that are relevant to those users' workflows and responsibilities.

### CROSS-REFERENCE TO RELATED APPLICATION

This application claims the benefit of U.S. Provisional Application No. 61/677,894 filed on Jul. 31, 2012 by Priya Kannan, et al., the entire disclosure of which is incorporated by reference herein.

### BACKGROUND

Oilfield operations, such as surveying, drilling, wireline testing, completions, production, planning and oilfield analysis, may be performed to locate and gather valuable downhole fluids. During the oilfield operations, data may be collected for analysis and/or monitoring of the oilfield operations. Such data may include, for example, subterranean formation, equipment, historical and/or other data. Data concerning the subterranean formation is collected using a variety of sources, and may be static or dynamic. Static data relates to, for example, formation structure, and geological stratigraphy that define the geological structures of the subterranean formation. Dynamic data relates to, for example, fluids flowing through the geologic structures of the subterranean formation over time. Such static and/or dynamic data may be collected to learn more about the formations and the valuable assets contained therein.

Sources used to collect static data may be seismic tools, such as a seismic truck that sends compression waves into the earth. Signals from these waves are processed and interpreted to characterize changes in the anisotropic and/or elastic properties, such as velocity and density, of the geological formation at various depths. This information may be used to generate basic structural maps of the subterranean formation. Other static measurements may be gathered using downhole measurements, such as core sampling and well logging techniques. Core samples may be used to take physical specimens of the formation at various depths. Well logging involves deployment of a downhole tool into the wellbore to collect various downhole measurements, such as density, resistivity, etc., at various depths. Such well logging may be performed using, for example, a drilling tool and/or a wireline tool. Once the well is formed and completed, fluid flows to the surface using production tubing and other completion equipment. As fluid passes to the surface, various dynamic measurements, such as fluid flow rates, pressure, and composition may be monitored. These parameters may be used to determine various characteristics of the subterranean formation.

Sensors may be positioned about an oilfield to collect data relating to various oilfield operations. For example, sensors in the drilling equipment may monitor drilling conditions, sensors in the wellbore may monitor fluid composition, sensors located along the flow path may monitor flow rates, and sensors at the processing facility may monitor fluids collected. Other sensors may be provided to monitor downhole, surface, equipment or other conditions. Such conditions may relate to the type of equipment at the wellsite, the operating setup, formation parameters, or other variables of the oilfield. The monitored data is often used to make decisions at various locations of the oilfield at various times. Data collected by these sensors may be further analyzed and processed. Data may be collected and used for current or future operations. When used for future operations at the same or other locations, such data may sometimes be referred to as historical data.

The data may be used to predict downhole conditions, and make decisions concerning oilfield operations. Such decisions may involve well planning, well targeting, well completions, operating levels, production rates and other operations and/or operating parameters. Often this information is used to determine when to drill new wells, re-complete existing wells, or alter wellbore production. Oilfield conditions, such as geological, geophysical and reservoir engineering characteristics may have an impact on oilfield operations, such as risk analysis, economic valuation, and mechanical considerations for the production of subsurface reservoirs.

Data from one or more wellbores may also be analyzed to plan or predict various outcomes at a given wellbore. In some cases, the data from neighboring wellbores or wellbores with similar conditions or equipment may be used to predict how a well will perform. Generally, a large number of variables and large quantities of data may be used to consider in analyzing oilfield operations. It is, therefore, often useful to model the behavior of the oilfield operation to determine the desired course of action. During the ongoing operations, the operating conditions may need adjustment as conditions change and new information is received.

Techniques have been developed to model the behavior of various aspects of the oilfield operations, such as geological structures, downhole reservoirs, wellbores, surface facilities as well as other portions of the oilfield operation. There are different types of simulators for different purposes. For example, there are simulators that focus on reservoir properties, wellbore production, or surface processing. Furthermore, attempts have been made to consider a broader range of data in oilfield operations and couple together different types of simulators.

Despite the development and advancement of managing oilfield data for oilfield operations, a need continues to exist for techniques for facilitating workflow collaboration and data sharing between multiple individuals. The amount of oil field data, or exploration and production data, available to exploration geoscientists and Exploration and Production (E&P) professionals is enormous. Exploration and production data is often stored in unstructured databases, resulting in inefficient management of exploration and production data and difficulty for users in locating relevant exploration and production data to their particular projects and tasks.

One specific difficulty encountered by many users, for example, relates to keeping abreast of the activities of other users. For example, some users may be responsible for the generation, collection and/or updating of certain oilfield data, while other users may be responsible for using that oilfield data, e.g., to perform simulations, to perform data analysis, to make business decisions, etc. It may be difficult, however, in many instances for those individuals who consume the oilfield data to be aware of when that data is stored and/or updated in a shared repository, and thus is available for use and analysis. Manual communication between individuals to inform one another of updates is both haphazard and unreliable. Furthermore, automatically notifying users of all updates to a shared repository would be untenable in many larger organizations as the frequency and volume of updates would overwhelm users with information that would likely be mostly irrelevant to their particular domains of responsibility.

Therefore, a substantial need continues to exist in the art for an improved manner of keeping users of a shared repository of oilfield data aware of relevant updates to the shared repository.

### SUMMARY

The embodiments disclosed herein provide a method, apparatus, and program product that implement a distributed subscription-based notification service for an integrated petro-technical application environment to facilitate the reporting of updates to oilfield data from a shared repository by a plurality of users. Users are permitted to generate custom notification subscriptions in a petro-technical application, such that oilfield data in the shared repository that meets subscription criteria associated with the notification subscriptions and that has been updated may be identified and used to generate a notification in the petro-technical application, thereby enabling individual users to customize their respective notifications based upon the particular types of data that are relevant to those users' workflows and responsibilities.

Therefore, consistent with one aspect of the invention, a user is notified of updates to data in a petro-technical application environment of the type having a shared repository in which is stored oilfield data. A plurality of notification subscriptions established for a user of the petro-technical application are processed to identify oilfield data in the shared repository that meets subscription criteria associated with the plurality of notification subscriptions, where each subscription criteria is configured to identify whether oilfield data meeting the subscription criteria and stored in the shared repository has been updated. Then, for each notification subscription for which the associated subscription criteria has been met, a notification is generated in the petro-technical application to identify to the user oilfield data from the shared repository that has been updated.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of a hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 is a block diagram illustrating notification subscriptions made on a shared repository in a petro-technical application environment in accordance with implementations of various technologies and techniques described herein.

FIG. 6 is a block diagram of a screen display associated with creating a folder-based notification subscription in accordance with implementations of various technologies and techniques described herein.

FIG. 7 is a block diagram of a screen display for an alert popup in accordance with implementations of various technologies and techniques described herein.

FIG. 8 is a block diagram of a screen display for a notification details pane in accordance with implementations of various technologies and techniques described herein.

FIG. 9 is a block diagram of a screen display for a subscription management window in accordance with implementations of various technologies and techniques described herein.

FIG. 10 is a block diagram of a screen display for a slide-out notification details pane in a petro-technical application in accordance with implementations of various technologies and techniques described herein.

FIG. 11 is a block diagram of a screen display for a tree view notification details pane in accordance with implementations of various technologies and techniques described herein.

FIG. 12 is a flowchart illustrating a sequence of operations performed by an edit/create subscription routine in accordance with implementations of various technologies and techniques described herein.

FIG. 13 is a flowchart illustrating a sequence of operations performed by a subscription monitor routine in accordance with implementations of various technologies and techniques described herein.

FIG. 14 is a flowchart illustrating a sequence of operations performed by a notification update routine in accordance with implementations of various technologies and techniques described herein.

FIG. 15 is a flowchart illustrating an alternate sequence of operations performed by a subscription monitor routine in accordance with implementations of various technologies and techniques described herein.

FIG. 16 is a flowchart illustrating a sequence of operations performed by a push thread routine in accordance with implementations of various technologies and techniques described herein.

FIG. 17 is a flowchart illustrating a sequence of operations performed by a suggestion thread routine in accordance with implementations of various technologies and techniques described herein.

### DETAILED DESCRIPTION

The herein-described embodiments of the invention provide a method, apparatus, and program product that implement a distributed subscription-based notification service for an integrated petro-technical application environment to facilitate the reporting of updates to oilfield data from a shared repository by a plurality of users. Users are permitted to generate custom notification subscriptions in a petro-technical application, such that oilfield data in the shared repository that meets subscription criteria associated with the notification subscriptions and that has been updated may be identified and used to generate a notification in the petro-technical application, thereby enabling individual users to customize their respective notifications based upon the particular types of data that are relevant to those users' workflows and responsibilities.

Subscription criteria may specify, for example, particular folders or filter criteria in a particular petro-technical application environment, and may specify additional details such as when data has been updated, particular data types, quality/status tags (e.g., complete data, in-progress data, etc.), source of data (e.g., a particular machine, a particular user, a group of users, etc.), when data was last edited, differences between user's data and the updated data, or practically any other data-based criteria. Furthermore, as will become more apparent below, notifications may be made via various user interface controls, e.g., notification panes, alert popups, visual notifications and highlights integrated into an application canvas, as well as other audio and/or visual-based alerts. As will also become more apparent below, subscriptions may be public or private, and various types of visualization techniques may be used to facilitate a user's understanding of what data in a shared repository has been updated.

Other variations and modifications will be apparent to one of ordinary skill in the art.

### Hardware and Software Environment

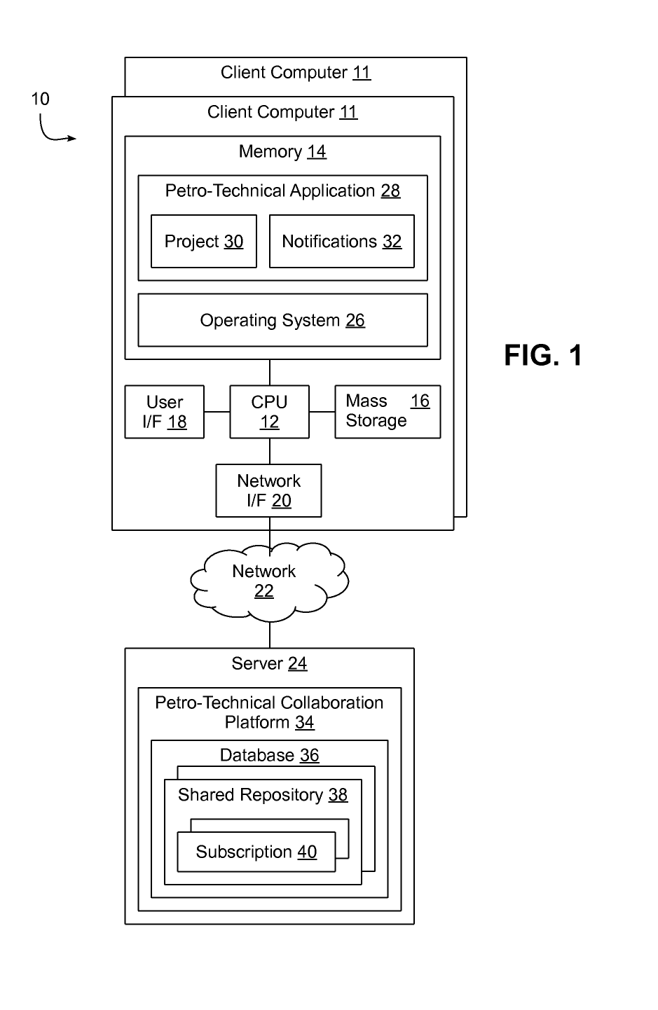

Turning now to the drawings, wherein like numbers denote like parts throughout the several views, FIG. 1 illustrates an example data processing system 10 in which the various technologies and techniques described herein may be implemented. System 10 is illustrated as including one or more computers 11, e.g., client computers, each including a central processing unit 12 including at least one hardware-based microprocessor coupled to a memory 14, which may represent the random access memory (RAM) devices comprising the main storage of a computer 11, as well as any supplemental levels of memory, e.g., cache memories, non-volatile or backup memories (e.g., programmable or flash memories), read-only memories, etc. In addition, memory 14 may be considered to include memory storage physically located elsewhere in a computer 11, e.g., any cache memory in a microprocessor, as well as any storage capacity used as a virtual memory, e.g., as stored on a mass storage device 16 or on another computer coupled to a computer 11.

Each computer 11 also generally receives a number of inputs and outputs for communicating information externally. For interface with a user or operator, a computer 11 generally includes a user interface 18 incorporating one or more user input devices, e.g., a keyboard, a pointing device, a display, a printer, etc. Otherwise, user input may be received, e.g., over a network interface 20 coupled to a network 22, from one or more servers 24. A computer 11 also may be in communication with one or more mass storage devices 16, which may be, for example, internal hard disk storage devices, external hard disk storage devices, storage area network devices, etc.

A computer 11 generally operates under the control of an operating system 26 and executes or otherwise relies upon various computer software applications, components, programs, objects, modules, data structures, etc. For example, a petro-technical application 28 may be used to manage one or more projects 30, and for which one or more notifications 32 may be generated. Application 28 may interface with a petro-technical collaboration platform 34, which may include a database 36 within which may be stored one or more shared repositories or projects 38, and with which may be associated one or more subscriptions 40. Collaboration platform 34 and/or database 36 may be implemented using multiple servers 24 in some implementations, and it will be appreciated that each server 24 may incorporate processors, memory, and other hardware components similar to a client computer 11. In addition, in some implementations platform 34 may be implemented within a database.

In one non-limiting embodiment, for example, petro-technical application 28 may be implemented as a desktop application compatible with the PETREL ® Exploration & Production (E&P) software platform, while petro-technical collaboration platform 34 may be implemented as the STUDIO E&P KNOWLEDGE ENVIRONMENT platform, both of which are available from Schlumberger Ltd. of Houston, Tex. and its affiliates. It will be appreciated, however, that the techniques discussed herein may be utilized in connection with other petro-technical applications, such that the invention is not limited to the particular software platforms and environments discussed herein.

In general, the routines executed to implement the embodiments disclosed herein, whether implemented as part of an operating system or a specific application, component, program, object, module or sequence of instructions, or even a subset thereof, will be referred to herein as “computer program code,” or simply “program code.” Program code generally comprises one or more instructions that are resident at various times in various memory and storage devices in a computer, and that, when read and executed by one or more processors in a computer, cause that computer to perform the steps embodying desired functionality. Moreover, while embodiments have and hereinafter will be described in the context of fully functioning computers and computer systems, those skilled in the art will appreciate that the various embodiments are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by computer 10. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the example environment illustrated in FIG. 1 is not intended to limit the invention. Indeed, those skilled in the art will recognize that other alternative hardware and/or software environments may be used without departing from the scope of the invention.

### Oilfield Operations

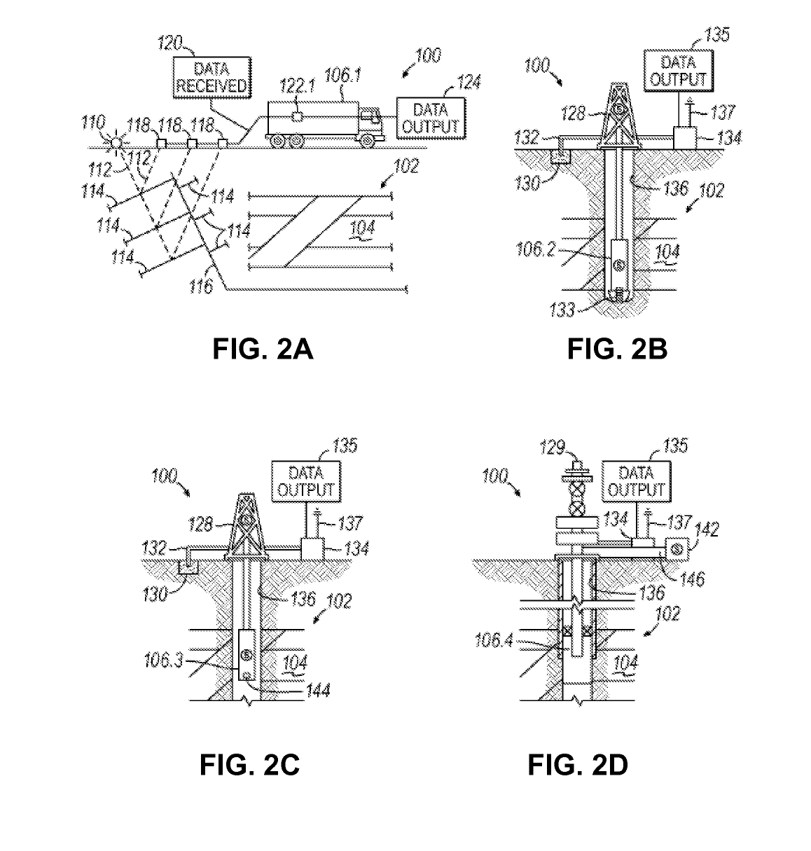

FIGS. 2a-2d illustrate simplified, schematic views of an oilfield 100 having subterranean formation 102 containing reservoir 104 therein in accordance with implementations of various technologies and techniques described herein. FIG. 2a illustrates a survey operation being performed by a survey tool, such as seismic truck 106.1, to measure properties of the subterranean formation. The survey operation is a seismic survey operation for producing sound vibrations. In FIG. 2a, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 2b illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud may be filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 2c illustrates a wireline operation being performed by wireline tool 106.3 suspended by rig 128 and into wellbore 136 of FIG. 2b. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 2a. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 2d illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 2b-2d illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2a-2d are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

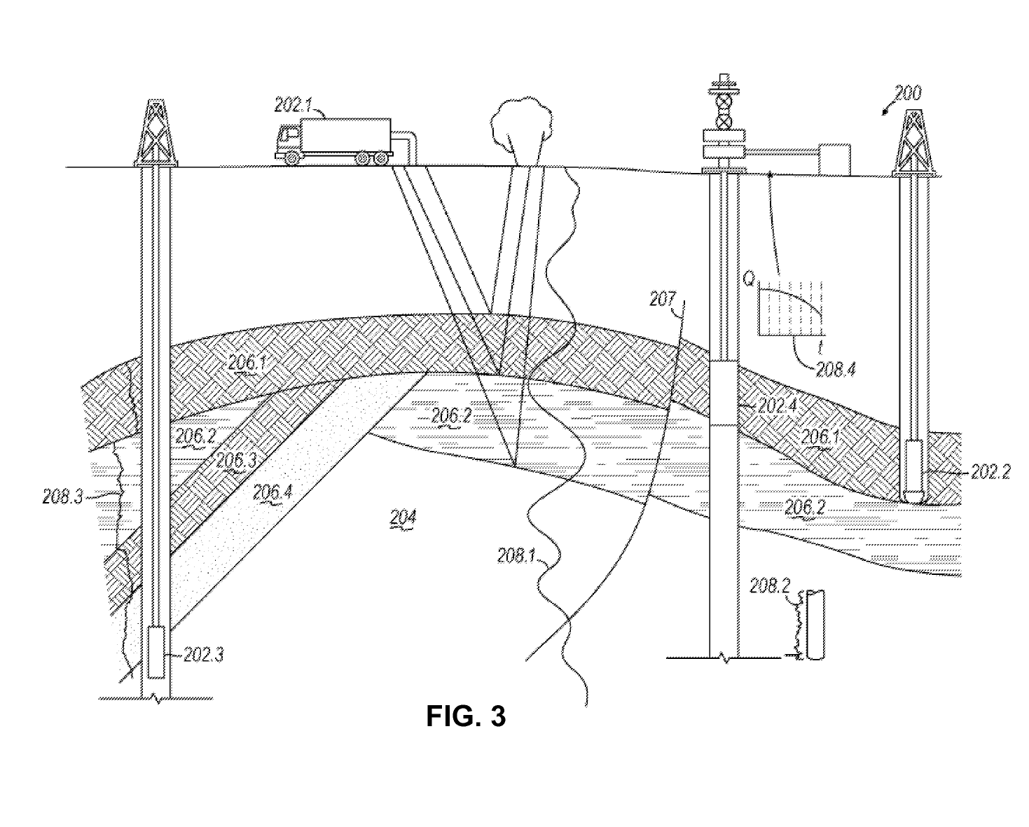

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2a-2d, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 3, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

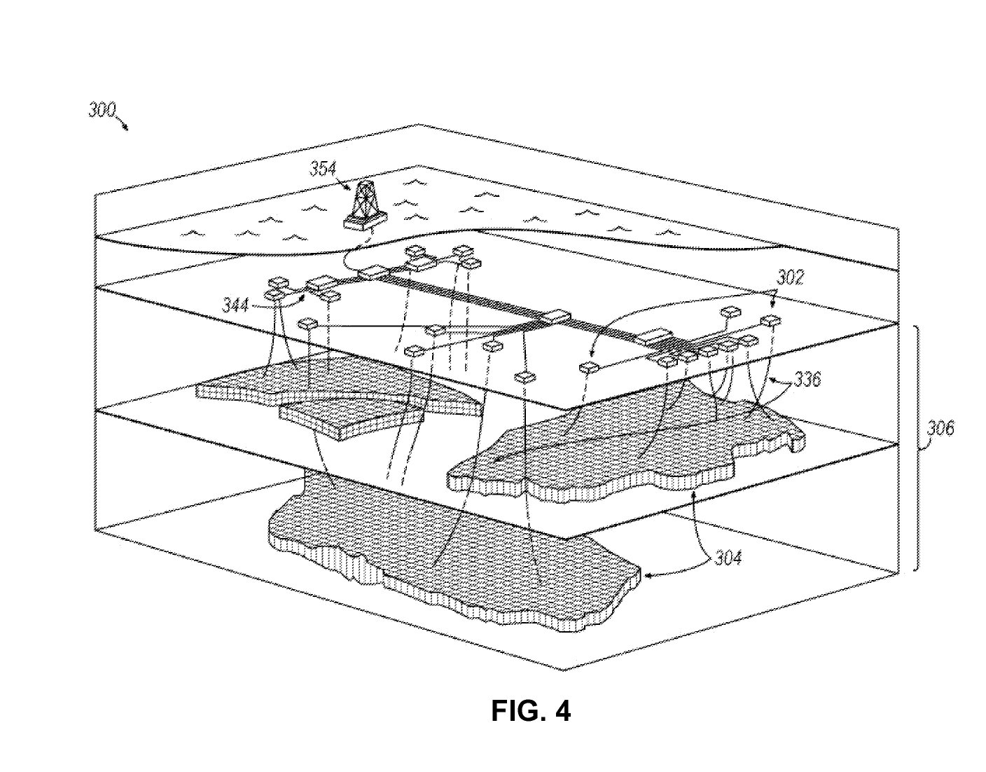

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part or all of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Distributed Subscription-Based Notification Service

As discussed above, embodiments of the invention implement a distributed subscription-based notification service in a petro-technical application environment, such as the PETREL Exploration & Production (E&P) software platform, to facilitate the notification of users of new and/or updated data stored in a shared data repository, e.g., in the aforementioned STUDIO E&P KNOWLEDGE ENVIRONMENT platform. A petro-technical application environment may be considered to include any number of application environments in which oilfield data and other data relevant to the oil & gas industry may be stored and accessed to and from one or more repositories, e.g., for performing various business operations such as data analysis, simulation, modeling, planning, forecasting, visualization, seismic interpretation, velocity modeling, depth conversion, well design, well correlation, etc. Furthermore, in the illustrated embodiments, the shared repositories may be shared by multiple individuals, including individuals with different responsibilities, different technical backgrounds, and different levels of expertise, and for different purposes. Moreover, such individuals may find, from time to time, that certain oilfield data may be generated, stored, deleted, updated and/or modified by other individuals, and that such oilfield data may be of interest to such individuals in the performance of their duties. In addition, teams of individuals may be working on the same projects, or on separate sub-projects or workflows within the context of the same overall project, such that sharing and collaboration between individuals necessitates that individuals be aware of the progress of other individuals in the team in terms of updating and or adding new data to a shared repository.

The distributed subscription-based notification service described herein is useful in one regard in allowing individuals, as users of the service, to subscribe to interested data so that such individuals will be notified in response to data changes made to a shared repository by other users of the shared repository. By doing so, user collaboration on shared data may be facilitated based upon the fact that users are able to establish subscription rules and/or filters (i.e., subscription criteria) that limit notifications to that data that is of interest to such users. Thus, in contrast to conventional approaches, which may rely on push notifications to alert all users as to all updates to a shared repository, the illustrated embodiments permit users to customize their notifications and thereby limit the volume of notifications and minimize notifications associated with data updates that are of no relevance to those users.

Among the features that may be supported in the illustrated embodiments include multi-user notifications, folder-based subscriptions, filter-based subscriptions, slide-out notification details user controls, and configurable notification details user controls. It will be appreciated that in some embodiments a subset of such features may be supported.

For example, some embodiments may support multi-user notifications by providing an ability for multiple users to subscribe to the same public filters and/or the same public data folders. By doing so, users may receive contextual notifications based on their particular data of interest and subscriptions.

Some embodiments may support user subscriptions to be established on a folder, e.g., within a petro-technical application environment in which data is organized into a multi-level folder-based hierarchy. As will become more apparent below, in one embodiment a user may identify a folder of interest in an input tree and subscribe to get notified on newer or conflicted data in a shared repository. Notifications may be presented to the user through a notification control, e.g., a popup control referred to herein as an alerts control. The alerts control may include links to summary information on updated data relevant to that folder, and functionality may be provided to enable a user to click on a link to show more details for a particular alert item.

Some embodiments may also support custom notification through filters, and may include practically any filter that may be implemented as a query on a shared repository or otherwise use to distinguish certain data stored in a shared repository from other data. For example, customized subscriptions may be made available through the use of a timestamp status (e.g., new/newer/conflicted/older/equal) constraint or criteria, along with additional user-defined filters related to the type and content of data desired.

Some embodiments may also support a slide-out notification details control, e.g., a pane or pop-up graphical user interface control. In one embodiment, a notification details control is presented as a slide-out pane that automatically disappears when user moves away from the pane. This allows the user to get back to working within the petro-technical application environment without additional windows that involve manual closing. In the embodiment, the details pane may default as a slide-out, and may be user configurable to operate instead as a floating window or other graphical user interface control.

Some embodiments may also support switchable views for notification details, e.g., to enable users to switch between list and tree views to facilitate access to updates to a shared repository.

Each of these features is discussed in greater detail below.

### Multi-User Notifications

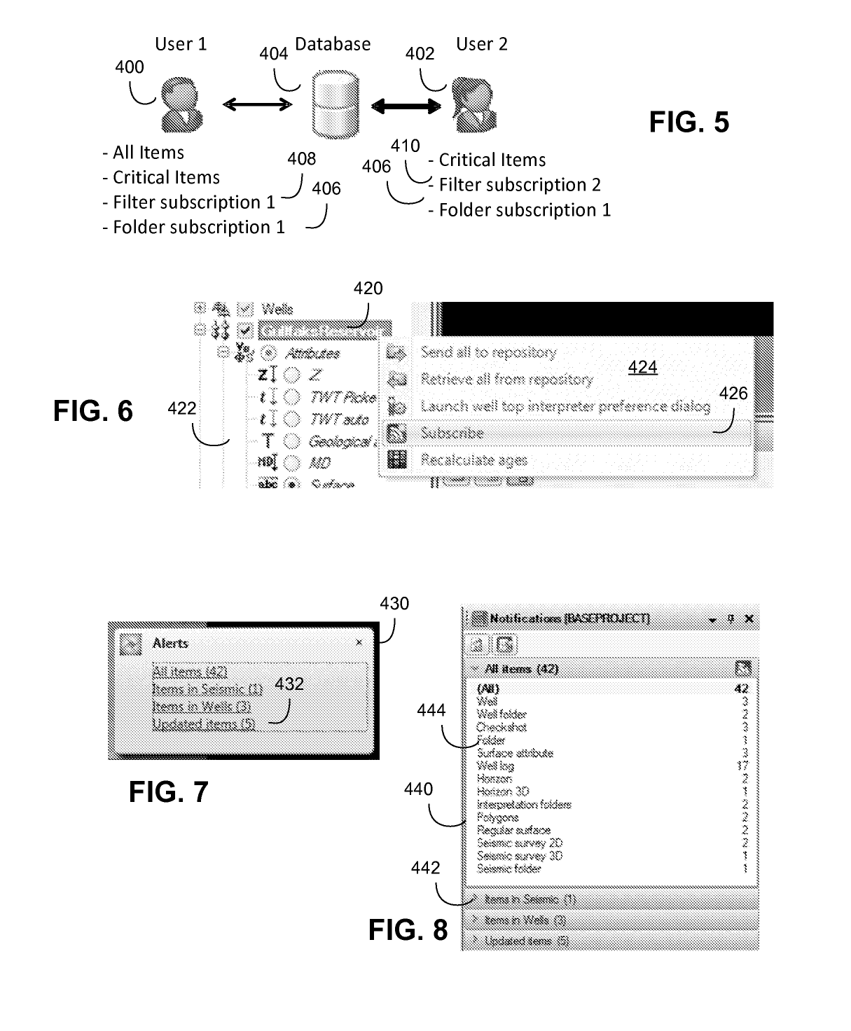

FIG. 5 illustrates a pair of users 400, 402 having access to a shared repository (database) 404. While not shown in FIG. 5, each user may access shared repository 404 through a petro-technical application, e.g., a desktop petro-technical application, and each may desire to receive notifications of updates made to specific data in the shared repository. Of note, in the illustrated embodiment, user subscriptions for a particular shared repository may be specifically configured for each user even in the case that a shared repository is shared, so that the relevant notifications are presented to the user. As such, for user 400, the user may have subscriptions established for items, for critical items, for a specific folder-based subscription 406 and a specific filter-based subscription 408, while user 402 may have similar subscriptions established for critical items and the same folder as user 400, but may have a different subscription 410 established for a different filter.

Two possible multi-user scenarios are addressed in FIG. 5.

First, from the perspective of a folder-based subscription such as subscription 406, notifications are shown if a specified folder that the user has subscribed to exists in the users context. At the same time if the folder does exist for more than one user's context, and the users have subscribed to that same folder, the users may be notified as to changes to data contained in that folder.

Second, from the perspective of a filter-based subscription such as subscriptions 408 and 410, filters allow users to see information as needed. In one embodiment, users may subscribe to any filter and get notifications for the changes that they are interested in. Filters may be made publicly available to all or groups of users and hence subscribing to them also allows awareness of data changes to multiple users.

### Folder-Based Subscriptions

FIG. 6 illustrates one example protocol through which a user may be permitted to subscribe to a folder. Here the user has clicked on a folder item 420 in an input tree 422 for the petro-technical application, which causes the application to open a context menu 424. The user may then subscribe to the folder by selecting the subscribe item 426 provided in the context menu. A subscription service, e.g., disposed in the user's local computer and/or in a server computer, may then create a folder-based subscription filter based on the selected folder and its globally unique identifier (GUID). Any new, newer and conflicted changes to this folder and the items under it would be then tracked and notified.

Notifications on the folder-based subscription may then be presented to the user through an alerts popup, e.g., as illustrated at 430 in FIG. 7. An alerts popup may be triggered, for example, on the receipt of updated data in a shared repository. The alerts popup may display the updates on the current subscriptions, e.g., in a format such as the name of the subscription followed by the data count, as illustrated by way of example at 432. The alerts popup may also include links to summary information on the updated data relevant to that folder, and a user may be permitted to click on a link to display more details for that item. Smart notification functionality may also allow for alerting users on strictly new information.

Furthermore, in some embodiments, a notification pane may be supported in addition or as an alternative to an alert popup. In one embodiment, for example, a petro-technical application environment may support a centralized notification pane, such as is shown at 440 in FIG. 8, that is available as a docking window in a petro-technical desktop application. Notification pane 440 includes a user's subscriptions, showing the name and total count for each. In addition, headers 442 may be provided such that when a subscription header is expanded, individual data type counts may be shown, as illustrated at 444. Users may then view the details for either all of the data types or just the data type of interest.

### Filter-Based Subscriptions

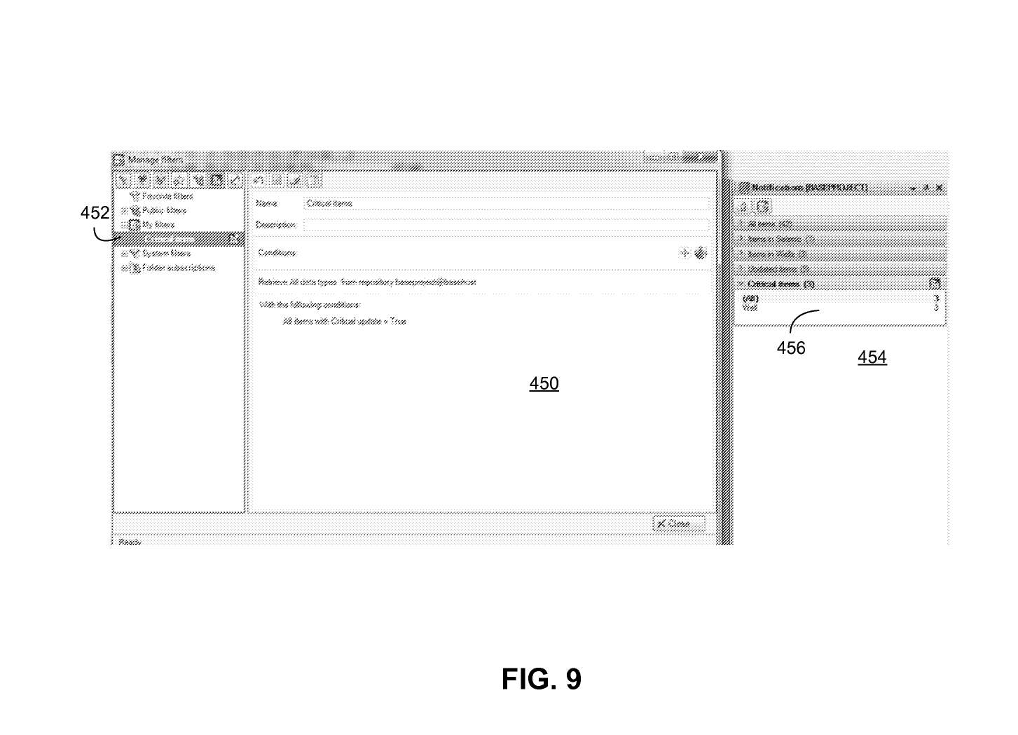

Next, as illustrated in FIG. 9, users may be permitted in some embodiments to create custom filters in the system and subscribe to the same. FIG. 9, in particular, illustrates a subscription management window 450 that may be used to manage a “critical items” filter 452, e.g., by configuring a name, description and one or more filter conditions, e.g., based upon dates, data types, data status, data sources, data tags, data categories, keywords, quality criteria (e.g., confidence factor, data status), geographical locations (e.g., using polygons or entering coordinates), user specific (e.g., data from user A or workgroup B), specific data criteria (e.g., domain, Seismic Reference Datum (SRD), deeper than x, name equal to x, etc.

In one embodiment, for example, a generic list of conditions may include business project, comments, confidence factor, created by, created by shared repository user, critical update, data status, date created, date created in shared repository, date updated, date updated in shared repository, name, original source, original source detail, path, synchronization status, update source, update source detail, updated by, and updated by shared repository user. In addition, in some embodiments, conditions may be context-specific so that, for example, for well items, the conditions may additionally include cost, Measured Depth (MD) at first point, MD at last point, operator, reference level, spud date, True Vertical Depth SubSea (TVDSS), Unique Well ID (UWI) and well symbol. Other context-specific conditions may also be used for other types of items.

Filter conditions may also include wildcards or other filter controls, and in some embodiments, may include practically any criteria that can be applied to the shared repository, e.g., via a query to the shared repository. Of note, FIG. 9 illustrates that the “critical items” filter-based subscription is for all data types from repository baseproject@basehost, and where the data items meet the condition “critical update =true.” Of note, the subscription is also shown in a notifications pane 454 at 456.

It will be appreciated that in some embodiments, and as shown in FIG. 9, both folder and filter-based subscriptions may be managed through the same interface. Furthermore, in some embodiments, folder-based subscriptions may be implemented as filter-based subscriptions where the filter criteria is based upon the selected folder. Controls for adding/modifying/deleting subscriptions may be provided, and security controls may be provided, e.g., to enable users to create or modify private or public subscriptions, as well as to limit what modifications may be made by certain users to some subscriptions. For example, in one embodiment, access may be limited to those with superuser or administrator rights in order to create, modify or delete public subscriptions.

### Slide-Out Notification Details Pane

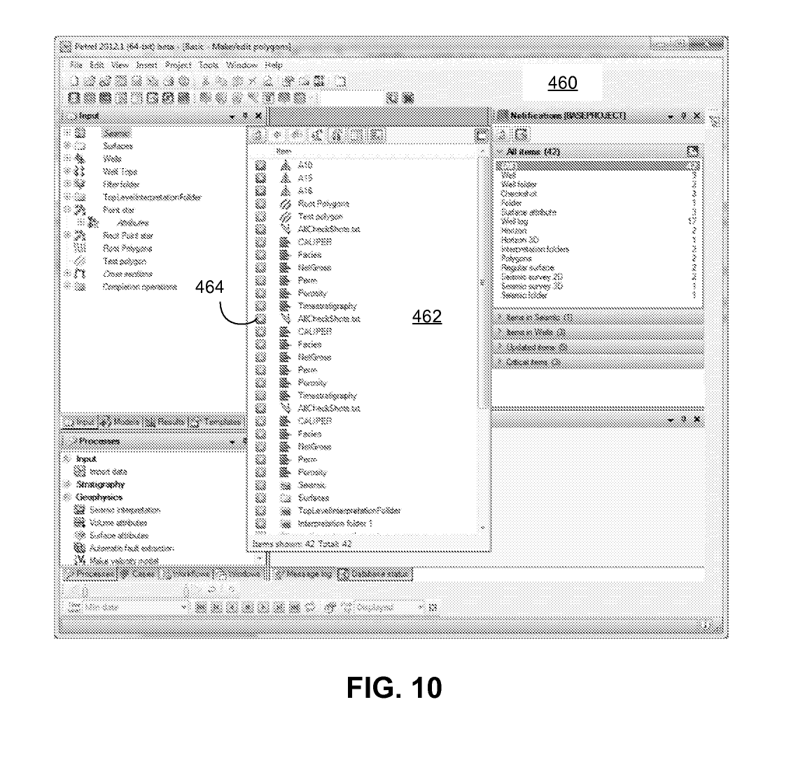

As noted above, notifications and alert details may be presented in a details pane. In some embodiments, e.g., as shown in FIG. 10, the pane may be disposed in an application workspace 460 and displayed as a slide-out pane 462 that retracts into the right edge of the workspace after a predetermined period of time. Otherwise, the pane may be implemented in a floating window mode in some embodiments.

In the details pane 462, it may be desirable for data items to have a color-coded timestamp status 464 to highlight differences. In some embodiments, a user may be permitted to compare information for particular data items and the changes may be color-coded. Based on this information, the user may then retrieve the selected data into the user's local workspace, e.g., into the user's local desktop application and local repository.

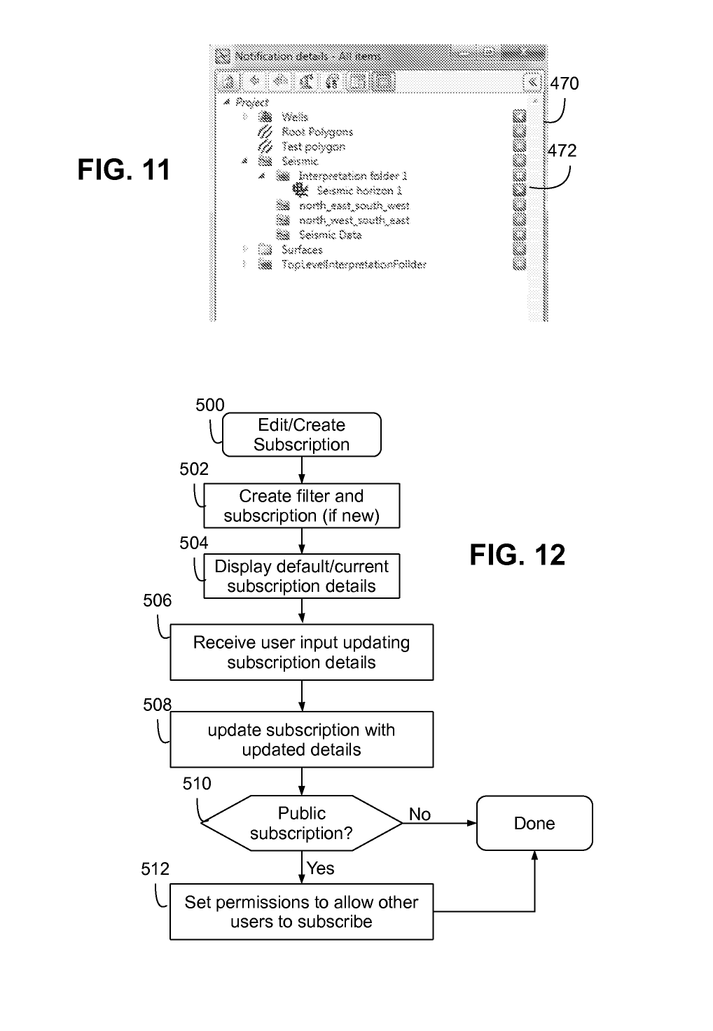

The default presentation may be through a List view, as shown in FIG. 10. However, in some embodiments, a user may switch to a tree view 470 (FIG. 11) to see the hierarchy of data items, with similar color-coded icons 472 utilized to represent status. In some embodiments, the user selections may be preserved from one view to the other.

It may also be desirable to provide user configurable options, e.g., to permit users to turn the notifications on/off, configure the notification refresh interval and turn an alerts popup on/off, among other configurations.

Now turning to FIG. 12, an example routine 500 suitable for editing and/or creating a subscription for a user is illustrated. Routine 500 may be executed, for example, by a local portion of a notification subscription service resident on a user's local computer, e.g., within a petro-technical desktop application. Otherwise, routine 500 may be resident on a server or otherwise remote from the user's local computer, e.g., based upon a web-based or other client-server protocol, or portions of routine 500 may be distributed among the client and server portions of a notification subscription service.

Routine 500 may be initiated, for example, in response to user input to add a new subscription or edit an existing subscription, e.g., via the interfaces illustrated in FIGS. 6 and 9. Routine 500 begins in block 502 by creating a filter and subscription in the shared repository, in the event that routine 500 is being executed to add a new subscription. Next, in block 504, default (in the case of a new subscription) or current (in the case of an existing subscription) details associated with the subscription are displayed to the user, e.g., in the fields displayed in the interface of FIG. 9. Next, in block 506, user input is received updating the displayed subscription details, and the resulting details are used in block 508 to update the subscription.

In some embodiments, a user may be permitted to add or edit public subscriptions, and as such, block 510 may determine whether the subscription is public, and if so, control may pass to block 512 to set permissions for the subscription to allow other users to access and use the subscription. For example, a user may be permitted to view public subscriptions and activate those subscriptions for the user's own personal use. A subscription may also be stored with user identification data to ensure that the user is associated with the subscription. Once the subscription is stored or updated in the shared repository, routine 500 is complete.

It will be appreciated that in the case of public subscriptions, synchronization functionality may be provided such that if one user modifies a public subscription, the modifications are propagated to other users of that subscription. Furthermore, it will be appreciated that in some embodiments, a user subscription may be created without displaying or receiving user input regarding some subscription details. For example, in the case of a folder-based subscription, selection of the context menu item to create a subscription, as discussed above in connection with FIG. 6, may require no further input on the part of the user. Thus, for example, blocks 504-508 may not be executed in some situations.

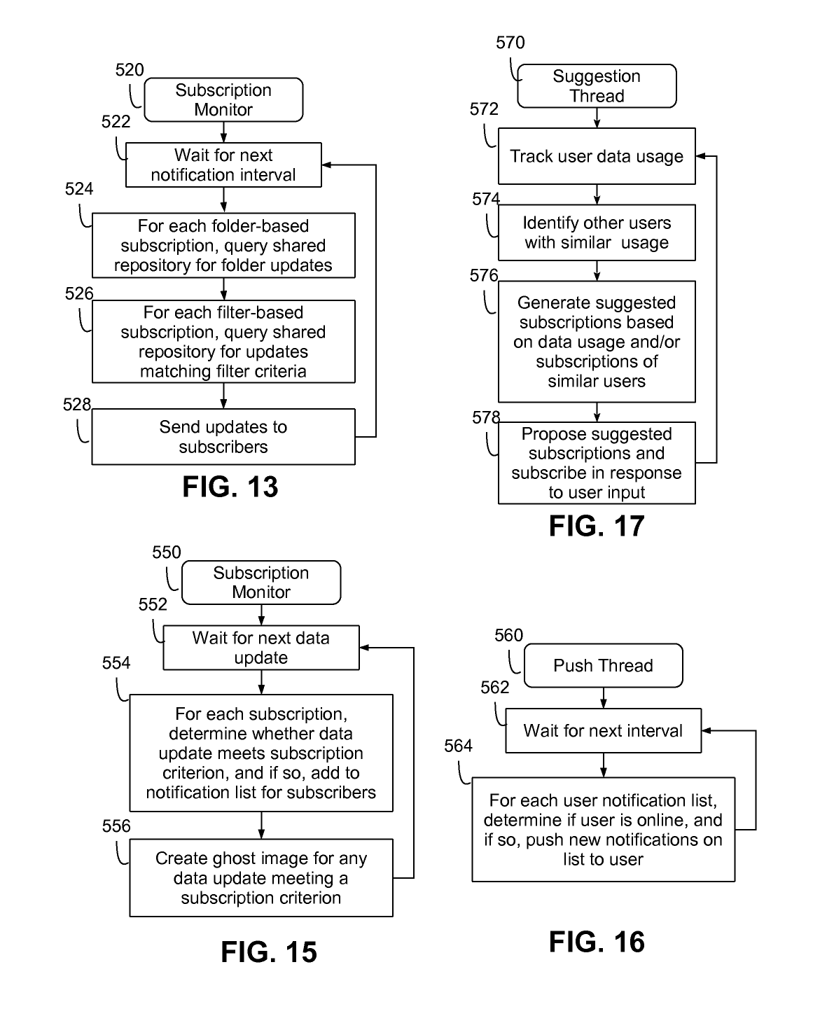

Once a subscription is created by a user, the subscription may be periodically accessed to determine whether any data associated with the subscription has been updated. FIG. 13, for example, illustrates a subscription monitor routine 520 that may run periodically to determine whether to signal any notifications associated with any subscriptions. Routine 520 begins in block 522 by waiting for a next notification interval. Once the next interval has arrived, control passes to block 524 to query the shared repository on behalf of each folder-based subscription, generally by issuing a query identifying the folder and any other subscription details and receiving updated information from the shared repository indicating whether any data items meet the subscription criteria.

Control passes to block 526 to query the shared repository on behalf of each filter-based subscription, generally by issuing a query identifying the filter criteria and any other subscription details and receiving update information from the shared repository indicating whether any data items meet the subscription criteria. It will be appreciated that in some embodiments, folder-based subscriptions may be implemented as filter-based subscriptions, whereby blocks 524 and 526 may be combined.

Next, in block 528 the updates for each subscription are sent to the relevant subscribers. Control then returns to block 522 to wait for the next notification interval.

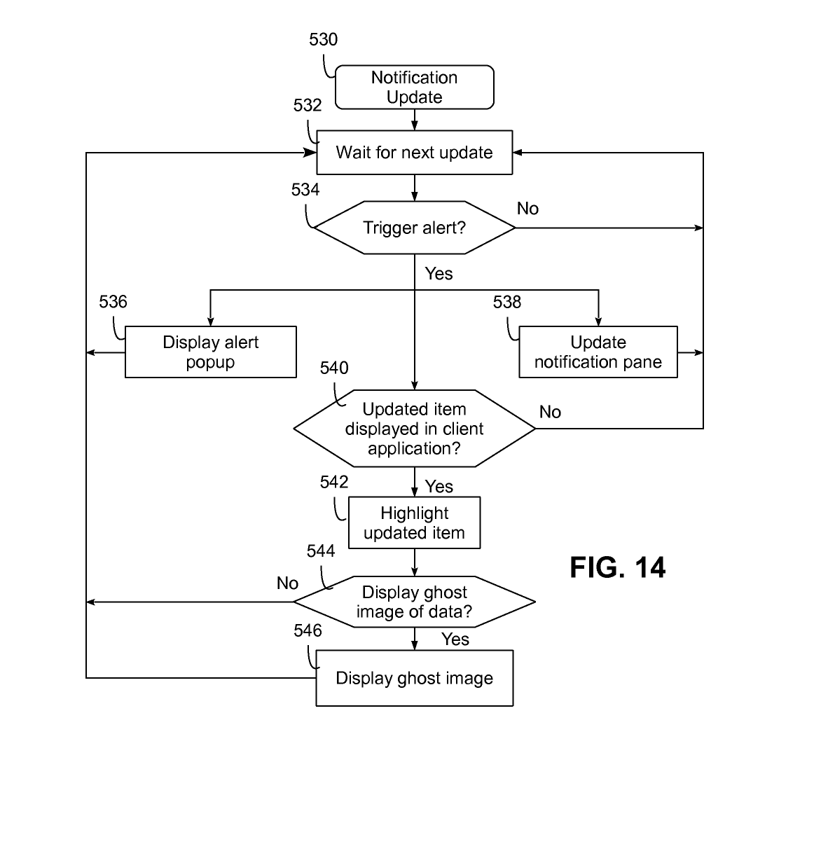

FIG. 14 next illustrates a notification update routine 530 that may be executed by each petro-technical application on a client computer to process the updates generated in block 528 of FIG. 13. Routine 530 begins in block 532 by waiting for the next update, and upon receiving an update, control passes to block 534 to determine whether to trigger an alert. If not, control returns to block 532. Otherwise, control passes to blocks 536, 538 and 540. Block 536 displays an alert popup and block 538 updates the notification based upon the received update.

In addition, in some embodiments, block 540 may be executed to determine whether any item associated with the update is currently displayed in the petro-technical application, e.g., within a 2D or 3D view currently being displayed to a user. If not, control returns to block 532. Otherwise, control passes to block 542 to highlight the updated item, e.g., by causing an icon or other indicator associated with the item to flash. Other manners of highlighting an item, e.g., through changes in color, font, size, etc. may be used in the alternative.

Next, control passes to block 544 to determine whether to display a ghost image of any of the updated data. In some embodiments, for example, it may be desirable to visualize differences in data to enable a user to make an informed decision as to whether to consume or load the updated item. In one embodiment, for example, differences between data in a 2D or 3D visualization and updated data may be highlighted by displaying the updated data as a ghost image in the 3D visualization. The ghost image may be configured, for example, as a downsampled image of the data that may be overlaid on the 2D or 3D visualization, so that a user can quickly ascertain whether the data is relevant to his or her workflow and if so, worth retrieving into the user's local project. If block 544 determines to display the ghost image, control passes to block 546 to display the ghost image. Otherwise, block 546 is bypassed and control returns to block 532 to wait for the next update.

FIG. 15 illustrates an alternate subscription monitor routine 550 to routine 520 of FIG. 13. Rather than periodically issuing queries to the shared repository as with routine 520, routine 550 is triggered off of changes being made to a shared repository, e.g., based off of transaction commits issued for the shared repository. Routine 550 therefore waits for updates to the shared repository in block 552, and in response to such an update, passes control to block 554 to access each subscription associated with the shared repository to determine whether the update meets the criterion of the subscription. In one embodiment, database changes may be made to an update log, and block 552 may monitor for changes to the update log.

For any subscription for which the criterion is met, the data update is added to a notification list for subscribers to the matching subscription. Then, in block 556, a ghost image is optionally created for relevant data updates so that, when the data updates are associated with a 2D or 3D visualization currently being displayed to a user, the ghost image will be available as an overlay for the visualization. Control then returns to block 552 to wait for new updates.

Next, as shown in FIG. 16, a push thread routine 560 may be used to propagate notifications to users when the users are online. Specifically, at periodic intervals (block 562), each user notification list (which is populated by routine 550 of FIG. 15) is accessed to determine (1) whether the associated user is currently online and (2) the list includes any notifications that have not yet been propagated to the user. For any such notifications, block 564 pushes the new notifications to the user and removes the notifications from the notifications list. Routine 530 of FIG. 14 then handles the display of such notifications to users in the manner discussed above.

It will be appreciated therefore that in the illustrated embodiment, subscriptions are generally customized for individual users. As such, in contrast with conventional non-filtered push-based notifications, the shared repository generally does not push notifications out to all users, and users have greater control over what notifications are generated for what data that is most relevant to their workflows. In addition, in many embodiments, the system may process subscriptions and populate user notification panes once instead of via repeated queries that might otherwise overburden the system, thereby avoiding network congestion by notifying once and on transaction commit boundaries. In some embodiments, quality tags may be used to enable users to be notified of finalized interpretations versus work in progress.

In addition, in some embodiments, filter criteria need not be based exclusively on updates or new data. For example, users may be permitted to define other filter criteria for a subscription, e.g., so that the user may have access to data of a certain type that is older than 3 years, or data relative to a particular depth. Also, in some embodiments, a user may be permitted to refresh notifications on demand.

FIG. 17 next illustrates yet another feature that may be implemented in some embodiments of the invention. As illustrated by suggestion thread routine 570, it may be desirable in some embodiments to automatically generate subscriptions based on monitored usage of a user. For example, block 572 may track user data usage, e.g., what types of data the user accesses, what folders the user commonly accesses, what visualizations a user frequently accesses, etc. Practically any user activities that may be useful in characterizing the user's workflow and usage of the petro-technical application may be used.

Next, as shown in block 574, the tracked usage may optionally be used to identify other users with similar usage characteristics. Then, in block 576, one or more suggested subscriptions may be generated based on the data usage and/or the subscriptions of similar users. In the former case, suggested subscriptions may be generated, for example, for frequently accessed data, folders, data sources, etc. In the latter case, suggested subscriptions may be generated, for example, based upon the subscriptions created for users having similar usage characteristics. Either or both of these cases may be supported, with the end result being that a user may be presented with one or more suggestions for additional subscriptions that may be relevant to that user's workflow.

Next, in block 578, the suggested subscriptions are proposed to the user, and the user is given the opportunity to accept or reject the suggested subscriptions, such that if accepted, the user is subscribed to the suggested subscriptions. In other embodiments, the subscriptions may be automatically created with initial results presented to a user along with an option to cancel the subscription.

While particular embodiments have been described, it is not intended that the invention be limited thereto, as it is intended that the invention be as broad in scope as the art will allow and that the specification be read likewise. It will therefore be appreciated by those skilled in the art that yet other modifications could be made without deviating from its spirit and scope as claimed.

What is claimed is:

1. A method of notifying a user of updates to data in a petro-technical application environment of the type having a shared repository in which is stored oilfield data, the method comprising:
processing a plurality of notification subscriptions established for a user of the petro-technical application to identify oilfield data in the shared repository that meets subscription criteria associated with the plurality of notification subscriptions, wherein each subscription criteria is configured to identify whether oilfield data meeting the subscription criteria and stored in the shared repository has been updated; and
for each notification subscription for which the associated subscription criteria has been met, generating a notification in the petro-technical application to identify to the user oilfield data from the shared repository that has been updated.

2. The method of claim 1, wherein a first notification subscription among the plurality of notification subscriptions is a folder-based subscription associated with a folder in the petro-technical application environment and configured to identify whether at least a portion of oilfield data organized in the folder has been updated, and wherein the method further comprises comprising generating the first notification subscription in response to user input directed to a graphical representation of the folder in the petro-technical application.

3. The method of claim 1, wherein a first notification subscription among the plurality of notification subscriptions is a filter-based subscription associated with a filter criteria and configured to identify whether at least a portion of oilfield data stored in the shared repository and meeting the filter criteria has been updated.

4. The method of claim 1, wherein a first notification subscription among the plurality of notification subscriptions is a public filter, wherein a plurality of users are subscribed to the first notification subscription.

5. The method of claim 1, wherein a first notification subscription among the plurality of notification subscriptions includes a timestamp criteria of new, newer, conflicted, older or equal.

6. The method of claim 1, wherein generating the plurality of notifications includes causing the petro-technical application to display an alert popup.

7. The method of claim 1, wherein generating the plurality of notifications includes causing the petro-technical application to display a notification details pane.

8. The method of claim 7, wherein the notification details pane is a slide-out notification details pane.

9. The method of claim 7, further comprising switching the notification details pane between list and tree views in response to user input.

10. The method of claim 7, further comprising expanding a subscription header in the notification details pane in response to user input to display data type counts associated with updates to different data types.

11. The method of claim 1, wherein the shared repository is resident on a different computer from the petro-technical application.

12. The method of claim 1, wherein processing the plurality of notification subscriptions is performed periodically and includes querying the shared repository based upon the subscription criteria associated with each notification subscription.

13. The method of claim 1, wherein processing the plurality of notification subscriptions is performed in response to an update in the shared repository.

14. The method of claim 13, wherein processing the plurality of notification subscriptions includes:
adding an update to a notification list associated with a first user that subscribes to a first notification subscription; and
pushing the update to the first user when the first user is online.

15. The method of claim 1, further comprising:
generating a ghost image associated with a updated data in the shared repository meeting the subscription criteria for a first notification subscription; and
displaying the ghost image on a visualization displayed in the petro-technical application.

16. The method of claim 1, further comprising automatically generating a suggested notification subscription.

17. The method of claim 16, wherein automatically generating the suggested notification subscription is based on tracked usage data.

18. The method of claim 16, wherein automatically generating the suggested notification subscription is based on a notification subscription associated with a second user determined to be similar to the first user.

19. An apparatus, comprising:
a client computer including at least one processor;
a petro-technical application resident in the client computer and configured to be executed by the at least one processor; and
program code configured upon execution by the at least one processor to notify a user of updates to data in a petro-technical application environment of the type having a shared repository in which is stored oilfield data by:
processing a plurality of notification subscriptions established for a user of the petro-technical application to identify oilfield data in the shared repository that meets subscription criteria associated with the plurality of notification subscriptions, wherein each subscription criteria is configured to identify whether oilfield data meeting the subscription criteria and stored in the shared repository has been updated; and
for each notification subscription for which the associated subscription criteria has been met, generating a notification in the petro-technical application to identify to the user oilfield data from the shared repository that has been updated.

20. A program product, comprising:
a computer readable medium; and
program code configured upon execution by at least one processor in a petro-technical application environment of the type having a shared repository in which is stored oilfield data, the program code configured to notify a user of updates to data by:
processing a plurality of notification subscriptions established for a user of the petro-technical application to identify oilfield data in the shared repository that meets subscription criteria associated with the plurality of notification subscriptions, wherein each subscription criteria is configured to identify whether oilfield data meeting the subscription criteria and stored in the shared repository has been updated; and
for each notification subscription for which the associated subscription criteria has been met, generating a notification in the petro-technical application to identify to the user oilfield data from the shared repository that has been updated.
